(19) United States
(12) Patent Application Publication
(10) Pub. No.: US 2023/0146708 A1
(43) Pub. Date: May 11, 2023

(54) CARRYING MECHANISM FOR USE IN MATTRESS PRODUCTION

(71) Applicant: ELEKTROTEKS ELEKTRONIK TEKSTIL SAN. VE TIC. LTD. STI., Bursa (TR)

(72) Inventors: Serkan GULER, Bursa (TR); Melih MOLLAOGLU, Bursa (TR)

(73) Assignee: ELEKTROTEKS ELEKTRONIK TEKSTIL SAN. VE TIC. LTD. STI., Bursa (TR)

(21) Appl. No.: 17/913,171

(22) PCT Filed: Apr. 5, 2021
(86) PCT No.: PCT/TR2021/050308

§ 371 Date: Sep. 21, 2022

(30) Foreign Application Priority Data
Jun. 8, 2020 (TR) 2020/08802

(51) Int. Cl. B68G 15/00; B23P 21/00

(52) U.S. Cl. CPC B68G 15/00; B23P 21/004

(57) ABSTRACT

A carrying mechanism for providing placement of at least one flexion item to a sponge pool having a lower sponge and a lateral sponge particularly used in mattress production includes at least one holder for fixing said flexion item thereon, at least one compression mechanism configured to at least partially compress the flexion item from the sides towards the center thereof, and at least one pushing group configured to separate the flexion item from the carrying mechanism in the sponge pool.

### CROSS REFERENCES TO THE RELATED APPLICATIONS

The application is the national phase entry of International Application No. PCT/TR2021/050308, filed on Apr. 5, 2021, which is based on and claims priority on Turkish patent application No. 2020/08802, filed on Jun. 8, 2020, the entire contents of which are incorporated herein by reference.

### BACKGROUND

Mattresses are used as household goods which are lied down into or onto for purposes like sleeping, having a rest. In the mattress structure, there are lower sponge, upper sponge and springs positioned in between. In order to prevent viewing of the springs from outside, there are lateral sponges which are from the edges of the lower sponge and the upper sponge towards each other. Thanks to the sponges, the user, who contacts the mattress, is prevented from being injured by the springs, and the springs provide comfortable lying and seating for the user.

In mattress production, first of all, the spring element is positioned on the lower sponge, and the upper sponge is positioned on the spring element. Said lateral sponge is connected by seaming or adhering to the lower sponge and to the upper sponge. Thanks to this, the springs are isolated from the outer medium, and the whole periphery of the mattress is made suitable to the person usage conditions.

In mattress production, non-aesthetical joining faults can be faced in the process of joining the lateral sponges to the lower sponge and to the upper sponge. Because of the flexion of the spring element and because of the non-rigid structure of the sponges, offset faults can occur while the sponges are being adhered to each other. Even though these faults can be eliminated manually by the workers as much as possible, production faults cannot be avoided. The occurrence of such faults leads to extra labor force and cost for the companies.

As a result, because of the abovementioned problems, an improvement is required in the related technical field.

### SUMMARY

The present invention relates to a carrying mechanism, for eliminating the abovementioned disadvantages and for bringing new advantages to the related technical field.

An object of the present invention is to provide a carrying mechanism for providing improvement of mattress production.

In order to realize the abovementioned objects and the objects which are to be deducted from the detailed description below, the present invention is at least one carrying mechanism for providing placement of at least one flexion item to the sponge pool having a lower sponge and lateral sponge particularly used in mattress production. Accordingly, the improvement of the present invention is that the subject matter carrying mechanism comprises at least one holder for fixing said flexion item thereon, at least one compression mechanism configured to at least partially compress the flexion item from the sides towards the center thereof, and at least one pushing group configured to separate the flexion item from the carrying mechanism in the sponge pool. Thus, the flexion item, used in mattress production, can be placed between the lower sponge and the lateral sponges.

In a possible embodiment of the present invention, said compression mechanism comprises at least one resting arm connected onto at least one body. Thus, the flexion item is pressed towards the center by means of the resting arm through the lateral sides.

In another possible embodiment of the present invention, said resting arm is connected to at least one arm movement group for providing movement of said resting arm in at least one axis X and in at least one axis Y on said body. Thus, the resting arm is moved on the body.

In another possible embodiment of the present invention, said arm movement group has at least one first plate and at least one second plate. Thus, movement capability is provided to the arm movement group in two axes.

In another possible embodiment of the present invention, said first plate is connected to at least one first guide for providing movement of said first plate essentially in axis Y on the body. Thus, the first plate moves linearly in axis Y.

In another possible embodiment of the present invention, in order to provide movement of said second plate in axis X, at least one second guide is provided between the first plate and the second plate. Thus, the second plate moves linearly in axis X.

In another possible embodiment of the present invention, the second plate is connected to at least one third guide for providing movement of the second plate in axis Y. Thus, the second plate moves linearly in axis Y.

In another possible embodiment of the present invention, said third guide is associated with at least one fourth guide for providing movement of said third guide in axis X. Thus, the third guide moves linearly in axis X.

In another possible embodiment of the present invention, at least one first drive element is provided which is configured to provide movement of the resting arm in axis Y. Thus, the resting arm is driven in axis Y.

In another possible embodiment of the present invention, at least one first movement transmission element is provided which is connected to said first drive element for providing movement of the resting arm in axis Y, and said first movement transmission element is configured to actuate the arm movement groups. Thus, the resting arm is driven in axis Y.

In another possible embodiment of the present invention, at least one second drive element is provided which is configured to provide movement of the resting arm in axis X. Thus, the resting arm is driven in axis X.

In another possible embodiment of the present invention, at least one second movement transmission element is provided which is connected to said second drive element for providing movement of the resting arm in axis X, and said second movement transmission element is configured to actuate the third guide. Thus, the resting arm is driven in axis X.

In another possible embodiment of the present invention, at least one connection group is provided for connection to the actuation system. Thus, the carrying mechanism is connected to the robotic system or to different actuation groups which have guides.

In another possible embodiment of the present invention, at least one pushing profile is provided in said pushing group. Thus, the pushing profile is rested to the flexion item and is separated from the holder.

In another possible embodiment of the present invention, said pushing profile is moved in an axis Z by at least one third drive element. Thus, the pushing profile provides movement in the direction of separating the flexion item from the holder.

In another possible embodiment of the present invention, the pushing profile is fixed, and the holder is at least partially moved in said axis Z. Thus, the holder is moved and the flexion item is rested to the pushing profile and is separated from the holder.

In another possible embodiment of the present invention, the holder is made so as to have pneumatic magnetic characteristic. Thus, the flexion item can be held and released without needing a pushing group.

### BRIEF DESCRIPTION OF THE DRAWINGS

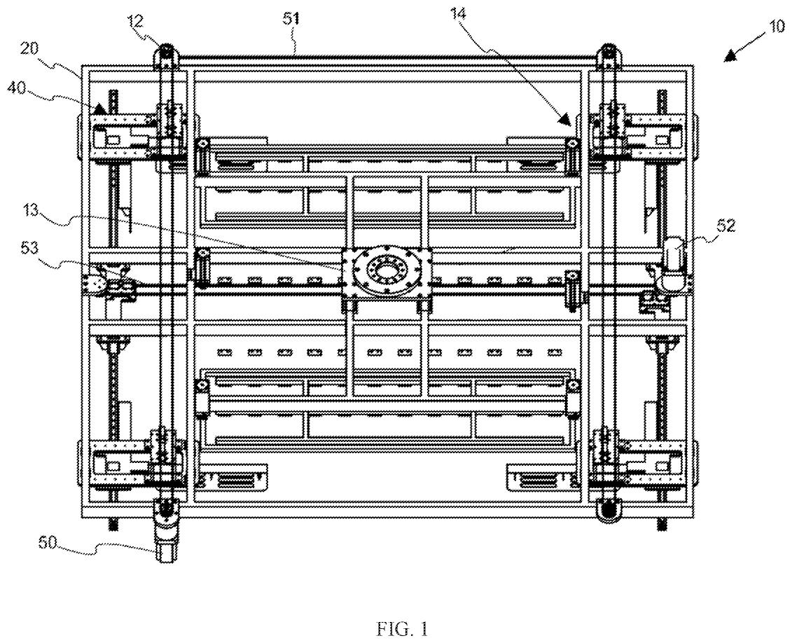

In FIG. 1, a representative top view of the subject matter carrying mechanism is given.

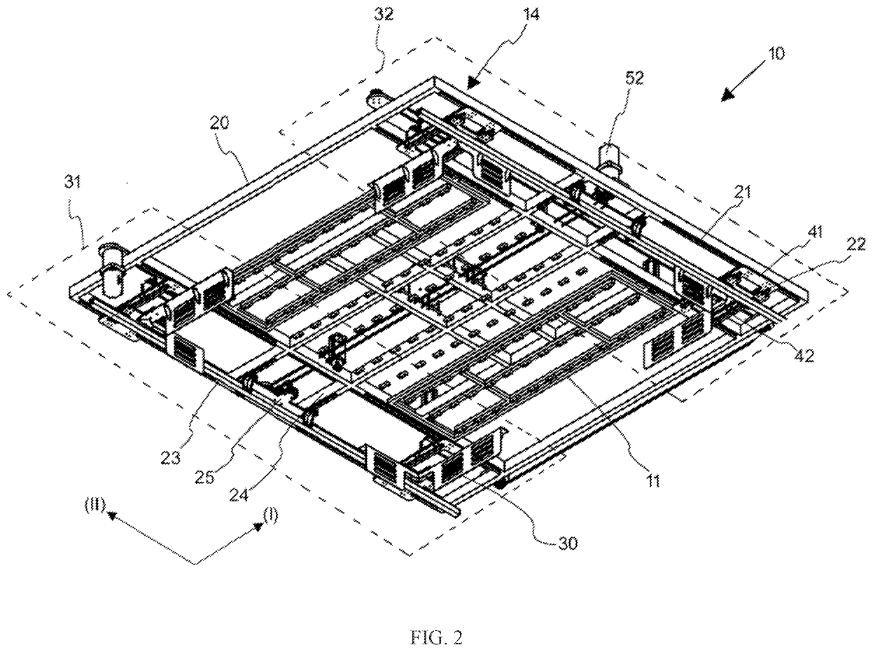

In FIG. 2, a representative perspective view of the subject matter carrying mechanism is given.

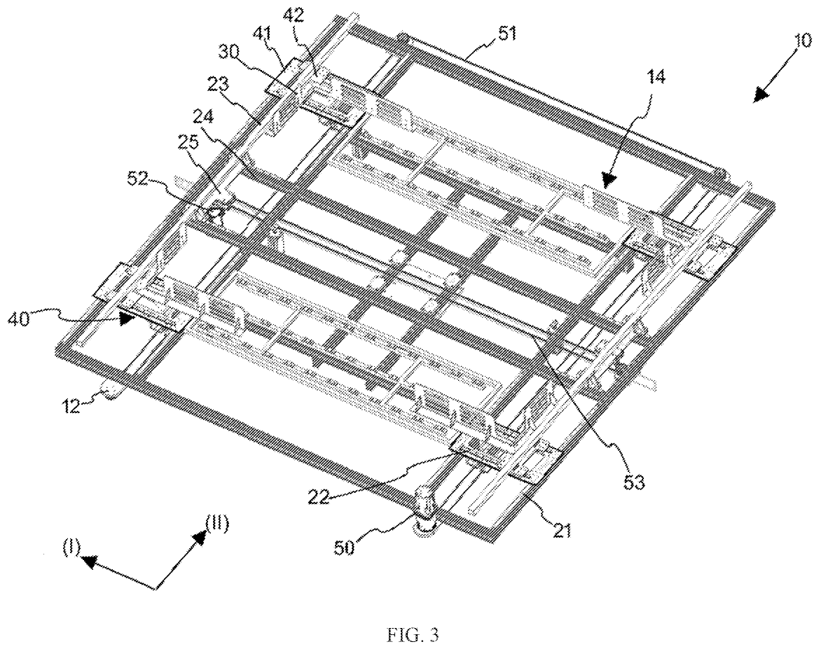

In FIG. 3, a representative perspective view of the subject matter carrying mechanism is given.

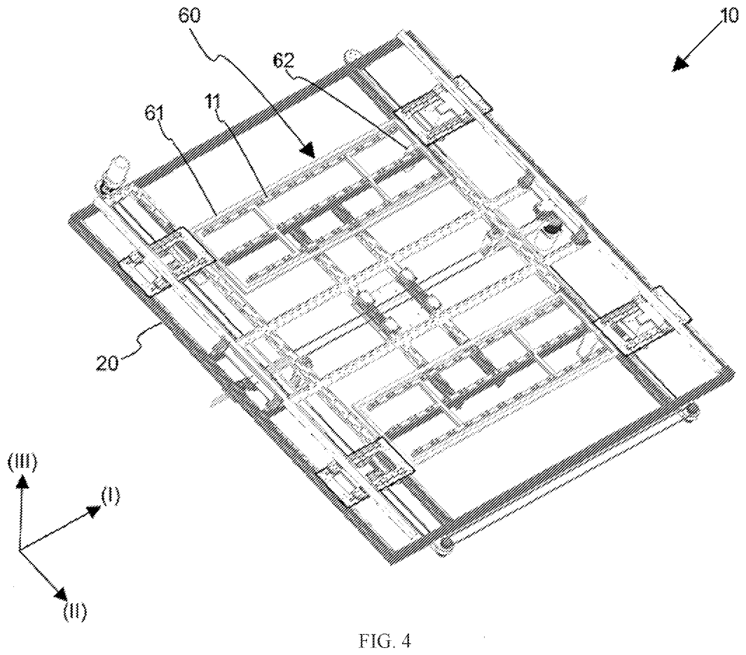

In FIG. 4, a representative perspective view of the subject matter carrying mechanism and of the pushing group positioned thereon is given.

In the figures, the reference numbers are as follows.
10 Carrying mechanism
11 Holder
12 Roller
13 Connection group
14 Compression mechanism
20 Body
21 First guide
22 Second guide
23 Third guide
24 Fourth guide
25 Guide bracket
30 Resting arm
31 First resting arm group
32 Second resting arm group
40 Arm movement group
41 First plate
42 Second plate
50 First drive element
51 First movement transmission element
52 Second drive element
53 Second movement transmission element
60 Pushing group
61 Pushing profile
62 Third drive element
(I) Axis X
(II) Axis Y
(III) Axis Z

### DETAILED DESCRIPTION OF THE EMBODIMENTS

In this detailed description, the subject matter is explained with references to examples without forming any restrictive effect only in order to make the subject more understandable.

In FIG. 1, a representative top view of the subject matter carrying mechanism (10) is given. Accordingly, the present invention relates to a carrying mechanism (10). The subject matter carrying mechanism (10) can be positioned on the actuation systems. Said actuation system can be a robotic element or a movement group having guide. The actuation system holds the flexion elements used in mattress production by means of the carrying mechanism (10) and leaves them into a sponge pool. The carrying mechanism (10) takes the flexion items from one place and at least partially compresses the flexion items by means of a compression mechanism (14) and places the flexion items between the base sponge and the lateral wall sponges in the sponge pool. In a possible embodiment of the present invention, said flexion element can be a spring-based element and can be a sponge-based element.

The carrying mechanism (10) has at least one body (20). Said body (20) provides holding of the flexion element thanks to the items provided on the body (20). The connection of the body (20) on the actuation system is provided by means of at least one connection group (13). Said connection group (13) is configured to be compliant to the system whereon the carrying mechanism (10) will be used. Holding of the flexion items on the body (20) is provided by means of at least one holder (11). In possible embodiments of the present invention, said holder (11) is essentially a neodymium-based magnetic holder, needle holder or a holder with compression through the edges. By means of the holder, the flexion item is held and moved together with the body.

In FIG. 2, a representative perspective view of the subject matter carrying mechanism (10) is given. Accordingly, in the compression mechanism (14) provided on the body (20), there is at least one resting arm (30) for providing compressing of the flexion item at least partially from the lateral sides thereof. In a possible embodiment of the present invention, said resting arm (30) essentially has “L” form and is configured to push the flexion item from the corner towards the middle thereof. In a possible embodiment of the present invention, four resting arms (30) are provided in order to exert pressure through the four corners of a flexion item having four corners in the carrying mechanism (10). The resting arms (30) can move in an axis X (I) and in an axis Y (II) on the body (20). Thanks to this, the flexion item is pushed from the corners towards the other corners, and the dimensions of the flexion item is at least partially reduced and compressed. In the compression mechanism (14), the resting arms (30) are configured to move together in the form of groups of two. In axis Y (II), the resting arms (30), positioned in the same direction, are named as the first resting arm group (31) and as the second resting arm group (32), and the resting arms (30), which exist in the same group, make symmetric movements with each other.

Connection of the resting arm (30) to the body (20) is provided by means of at least one arm movement group (40). Said arm movement group (40) provides actuation of the resting arm (30) in axis X (I) and in axis Y (II), and said arm movement group (40) is provided in number, which is equal to the number of resting arms (30), on the body (20). In order to provide actuation of the arm movement groups (40), there is at least one first guide (21), at least one second guide (22), at least one third guide (23) and at least one fourth guide (24) in the compression mechanism (14). Said guides facilitate movement of the resting arms (30) on the body (20) in predetermined directions. Said first guide (21) and said third guide (23) are essentially positioned in a parallel manner to axis Y (II) and provide movement of the arm movement group (40) in axis Y (II). Said second guide (22) and said fourth guide (24) are positioned in a parallel manner to axis X (I) and provide movement of the arm movement group (40) in axis X (I). The third guide (23) and the fourth guide (24) are essentially positioned in an orthogonal manner to each other and they are associated with each other by means of at least one guide bracket (25). While said guide bracket (25) is essentially connected in a fixed manner on the third guide (23), the fourth guide (24) is associated in a manner making sliding movement on the bracket.

At the arm movement groups (40) in the compression mechanism (14), there is at least one first plate (41) and at least one second plate (42). The movement of the arm movement groups (40) both in axis X (I) and axis Y (II) is provided by means of the two-pieced structure thereof. Said first plate (41) is essentially positioned on the first guide (21) and can move in the direction of axis Y (II) at least partially. In a possible embodiment of the present invention, the first plate (41) is connected to two first guides (21) that are parallel to each other. In other words, two each separate first guides (21) are provided for the first resting arm group (31) and the second resting arm group (32).

Said second plate (42) can move essentially in axis X (I) on the first plate (41). In order to realize this movement, said second guide (22) is positioned between the first body (20) and the second body (20). Moreover, the second guide (22) is connected to said third guide (23) from one side and can move in axis X (I) from one side and can move in axis Y (II) from the other side.

The resting arms (30) provided in the same resting arm groups can be approached to each other and moved away from each other at the same distance on the third guide (23). The first resting arm group (31) and the second resting arm group (32) can be approached to each other and moved away from each other by means of sliding of the third guides (23) on said fourth guide (24).

In FIG. 3, a representative perspective view of the subject matter carrying mechanism (10) is given. Accordingly, at least one first drive element (50) and at least one second drive element (52) are positioned in the carrying mechanism (10). Said first drive element (50) is configured to provide movement of the resting arms (30) in axis Y (II). Said second drive element (52) provides movement of the resting arms (30) in axis X (I).

In order for the first drive element (50) to move the resting arms (30), at least one first movement transmission element (51) is positioned on the body (20). Said first movement transmission element (51) is essentially a toothed rack, a screwed shaft or a belt and is essentially provided in “U” form on the body (20). The first movement transmission element (51) provides wrapping and movement by means of at least one roller (12) positioned on the body (20) with the first resting arm group (31) and the second resting arm group (32) because of the form of the first movement transmission element (51). Pluralities of rollers (12) can be provided on the body (20) and can be essentially rotated around the own axis thereof. The first movement transmission element (51) is connected to the first plates (41) of the resting arms (30) by means of gears (not shown in the figures). Thanks to this, the resting arms (30), provided on the same arm group, can be moved towards each other.

In order to provide movement of the resting arms (30) by the second drive element (52), at least one second movement transmission element (53) is positioned on the body (20). Said second movement transmission element (53) can essentially be a toothed rack, a screwed shaft or a belt like the first movement transmission element (51). The second movement transmission element (53) is essentially positioned in the direction of axis X (I) on the body (20) and provides movement of the third guide (23) on the fourth guide (24).

In FIG. 4, a representative perspective view of the subject matter carrying mechanism (10) and of at least one pushing group (60) positioned thereon is given. Accordingly, said pushing group (60) is configured to provide pushing of the flexion item, held by the holder (11) and narrowed through the lateral sides by means of the compression mechanism (14), into the sponge pool. In order to realize this, the pushing group (60) has at least one pushing profile (61) on the body (20). Said pushing profile (61) is positioned around the holder (11) and can move in an axis Z (III) at least partially. The movement of the pushing profile (61) is provided by means of at least one third drive element (62). Thanks to this, the flexion item is separated from the holder (11) and can be placed without needing loosening of the compression mechanism (14). In alternative embodiments of the present invention, the pushing profile (61) is motionless, and the holder (11) can be moved in axis Z (III). In this case, the flexion item can be rested to the pushing profile (61) and can be separated from the holder (11). In another alternative embodiment of the present invention, the holder (11) is a cylinder with pneumatic magnetic characteristics. In this case, the holder (11) can both hold and push the flexion item on the body (20) without needing the pushing group (60).

In a possible usage of the present invention, the carrying mechanism (10) positioned on the actuation system is positioned at the upper vicinity of the flexion item and holds the flexion item by means of the holder (11). Force is exerted to the lateral sides of the held flexion item by means of the compression mechanism (14) and the flexion item is compressed towards the middle thereof. Afterwards, the flexion item is placed between the sponges prepared for mattress production and the pushing group (60) separates the flexion item from the holder (11). During these processes, the resting arms (30) are actuated by means of arm movement groups (40) and by means of the elements which move the arm movement groups (40).

By means of all these embodiments, the joining faults are prevented, which occur in the process of joining of the lateral sponges to the lower sponge and to the upper sponge depending on the volume of the flexion items in mattress production. The labor, time and cost losses needed for elimination of these faults are prevented.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

1. A carrying mechanism for providing placement of at least one flexion item to a sponge pool having a lower sponge and a lateral sponge particularly used in mattress production, wherein the carrying mechanism comprises
at least one holder for fixing the at least one flexion item on the at least one holder,
at least one compression mechanism configured to at least partially compress the at least one flexion item from sides towards a center of the at least one compression mechanism, and
at least one pushing group configured to separate the at least one flexion item from the carrying mechanism in the sponge pool.

2. The carrying mechanism according to claim 1, wherein the at least one compression mechanism comprises at least one resting arm connected onto at least one body.

3. The carrying mechanism according to claim 2, wherein the at least one resting arm is connected to at least one arm movement group for providing movement of the at least one resting arm in an axis X and in an axis Y on the at least one body.

4. The carrying mechanism according to claim 3, wherein the at least one arm movement group has at least one first plate and at least one second plate.

5. The carrying mechanism according to claim 4, wherein the at least one first plate is connected to at least one first guide for providing movement of the at least one first plate essentially in the axis Y on the at least one body.

6. The carrying mechanism according to claim 4, wherein to provide movement of the at least one second plate in the axis X, at least one second guide is provided between the at least one first plate and the at least one second plate.

7. The carrying mechanism according to claim 4, wherein the at least one second plate is connected to at least one third guide for providing movement of the at least one second plate in the axis Y.

8. The carrying mechanism according to claim 7, wherein the at least one third guide is associated with at least one fourth guide for providing movement of the at least one third guide in the axis X.

9. The carrying mechanism according to claim 2, wherein at least one first drive element is provided which is configured to provide movement of the at least one resting arm in the axis Y.

10. The carrying mechanism according to claim 9, wherein at least one first movement transmission element is provided which is connected to the at least one first drive element for providing movement of the at least one resting arm in the axis Y, and the at least one first movement transmission element is configured to actuate arm movement groups.

11. The carrying mechanism according to claim 2, wherein at least one second drive element is configured to provide movement of the at least one resting arm in the axis X.

12. The carrying mechanism according to claim 11, wherein at least one second movement transmission element is connected to the at least one second drive element for providing movement of the at least one resting arm in the axis X, and the at least one second movement transmission element is configured to actuate a third guide.

13. The carrying mechanism according to claim 1, wherein at least one connection group is provided for connection to an actuation system.

14. The carrying mechanism according to claim 1, wherein at least one pushing profile is provided in the at least one pushing group.

15. The carrying mechanism according to claim 14, wherein the at least one pushing profile is moved in an axis Z by at least one third drive element.

16. The carrying mechanism according to claim 14, wherein the at least one pushing profile is fixed, and the at least one holder is at least partially moved in an axis Z.

17. The carrying mechanism according to claim 1, wherein the at least one holder is made to have pneumatic magnetic characteristic.
